(19) United States
(12) Patent Application Publication
(10) Pub. No.: US 2020/0310778 A1
(43) Pub. Date: Oct. 1, 2020

(54) SYSTEM AND METHOD FOR CUSTOMER DEFINABLE SOFTWARE DISTRIBUTION

(71) Applicant: Avaya Inc., Santa Clara, CA (US)

(72) Inventor: Kurt Haserodt, Westminster, CO (US)

(21) Appl. No.: 16/366,508

(22) Filed: Mar. 27, 2019

(51) Int. Cl. G06F 8/65; H04L 12/24; G06F 8/10; G06F 8/77

(52) U.S. Cl. CPC G06F 8/65; H04L 41/0886; G06F 8/77; G06F 8/10; H04L 41/082

(57) ABSTRACT

An availability of a software upgrade is determined for a software product. A software upgrade may be a new version of the software product, a service pack, a security patch, etc. A system of a customer is identified that has been installed with the software product. For example, a server of the customer is identified. One or more customer upgrade requirements are identified. For example, a cost of the customer upgrade is identified. The one or more customer upgrade requirements are based on one or more product attributes associated with the software upgrade. A product attribute may be a type of upgrade, such, as a service pack upgrade. If it is determined that the one or more customer upgrade requirements have been met, the software upgrade to the software product is downloaded to the system.

### FIELD

The disclosure relates generally to software distribution systems and particularly to customer definable software distribution.

### BACKGROUND

Delivery and installation of new server software typically requires human thought, complex planning, and is time consuming. This can often become a barrier to fixing and securing existing services and adopting new services. Newer technologies allow for better automation of this process, thus reducing the time consumption barrier, but to make things fully automatic, the human thought and complex planning barriers remains to be solved.

### SUMMARY

These and other needs are addressed by the various embodiments and configurations of the present disclosure. An availability of a software upgrade is determined for a software product. A software upgrade may be a new version of the software product, a service pack, a security patch, etc. A system of a customer is identified that has been installed with the software product. For example, a server of the customer is identified. One or more customer upgrade requirements are identified. For example, a cost of the customer upgrade is identified. The one or more customer upgrade requirements are based on one or more product attributes associated with the software upgrade. A product attribute may be a type of upgrade, such, as a service pack upgrade. If it is determined that the one or more customer upgrade requirements have been met, the software upgrade to the software product is downloaded to the system.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 1140 and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “software upgrade” as defined herein and in the claims can be or may include a new software upgrade (i.e., a new version), a patch, a single bug fix, a security patch, a service pack, a minor functionality change, a major functionality change, specific feature(s) changes, and/or the like. In other words, a software upgrade is where there is some type of change over a previous version of a software product.

As defined herein and in the claims, the term “software product” refers to the first release of software that then may be updated with a software upgrade. For example, a software product that is an official release (e.g., version 1.0) that may be updated with a software update to become version 1.1.

The term “system” as defined herein and in the claims can be or may include a one or more: user devices/endpoints, servers, Session Border Controllers (SBCs), communication systems, telephones, routers, mobile devices, network elements, switches, and/or the like.

The term “customer” as defined herein and in the claims can be or include any an individual person, a group of persons, a company, an enterprise, an organization, an artificial intelligence, and/or process that that wants to upgrade a software product. A customer who does not purchase the software upgrade and/or product is still considered a customer.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for automating a software download process.

FIG. 2 is a block diagram of a second illustrative system for automating a software download process.

FIG. 3 is a diagram of a user interface for defining software upgrade attributes.

FIG. 4 is a diagram of a user interface for defining software upgrade attributes for a specific customer.

FIG. 5 is a diagram of a user interface for defining customer upgrade requirements and customer installation requirements.

FIG. 6 is a flow diagram of a process for automating a software download process.

FIG. 7 is a flow diagram of a process for managing time related customer upgrade requirements.

FIG. 8 is a flow diagram of a process for using Artificial Intelligence (AI) in managing a software download process.

### DETAILED DESCRIPTION

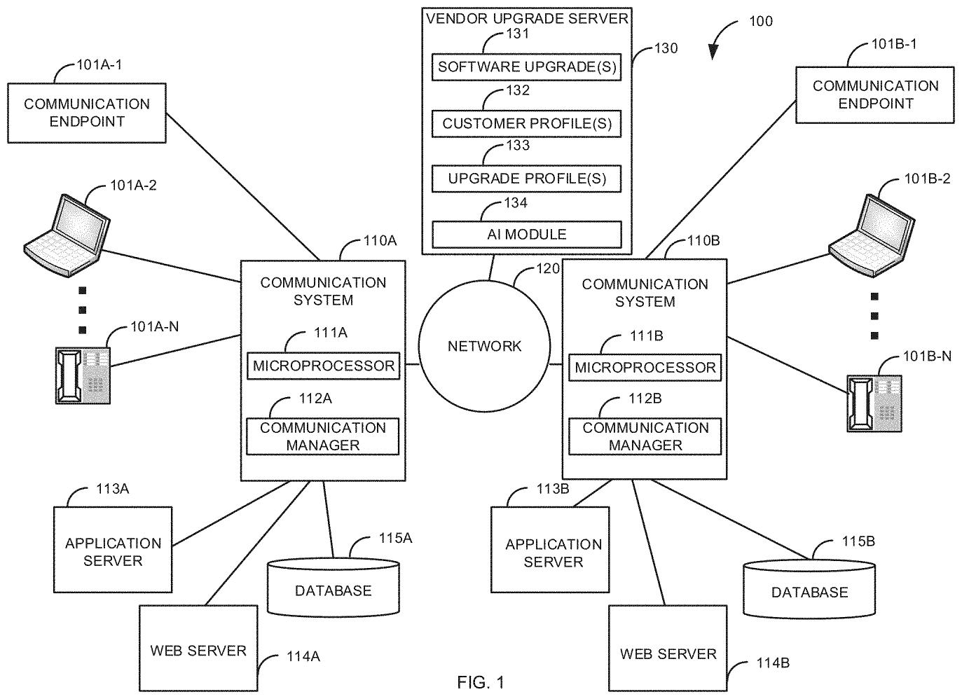

FIG. 1 is a block diagram of a first illustrative system 100 for automating a software download process. The first illustrative system 100 comprises communication endpoints 101A-1-101A-N, communication endpoints 101B-1-101B-N, communication systems 110A-110B, application servers 113A-113B, web servers 114A-114B, databases 115A-115B, a network 120, and a vendor upgrade server 130.

The communication endpoints 101A-1-101A-N and 101B-1-101B-N can be or may include any user communication endpoint device that can communicate on the network 110, such as a Personal Computer (PC), a telephone, a video system, a cellular telephone, a Personal Digital Assistant (PDA), a tablet device, a notebook device, a media server, a smartphone, and/or the like. The communication endpoints 101A-1-101A-N and 101B-1-101B-N are devices where a communication sessions ends. The communication endpoints 101A-1-101A-N and 101B-1-101B-N are not network elements that facilitate and/or relay a communication session in the network, such as a communication manager 112 or router. As shown in FIG. 1, any number of communication endpoints 101A-1-101A-N and 101B-1-101B-N may be connected to the communication systems 110A-110B.

The communication systems 110A-110B can be any network communication systems that provide various services to the user communication endpoints 101A-1-101A-N and 101B-1-101B-N, such as a Private Branch Exchange (PBX), a server, a central office switch, a router, a proxy server, a session manager, an email system, an Instant Messaging system, a text messaging system, a gaming system, a media server, and/or the like. Although only two communication systems 110A-110B are shown, any number of communication systems 110 may be attached to the network 120 for downloading new software and/or upgrades.

The communication systems 110A-110B further comprise microprocessors 111A-111N and communication managers 112A-112B. The microprocessors 111A-111B can be or may include any hardware microprocessor, such as, a multi-core processor, a micro-controller, an application specific processor, a digital signaling processor, and/or the like.

The communication managers 112A-112N can be or may include any hardware/software that can manage, provide, route, and/or generate various types of communications/communication services, such as a PBX, a server, a router, a proxy server, and/or the like.

The application servers 113A-113B can be or may include any server that can provide an application/information for use by the user communication endpoints 101A-1-101A-N and 101B-1-101B-N and/or the communication systems 110A-110B.

The web servers 114A-114N can be or may include any known type of web server/web pages that can provide web services to the user communication endpoints 101A-1-101A-N and 101B-1-101B-N.

The databases 115A-115N can be or may include any database for storing information, such as, a directory service, a relational database, an object oriented database, a file system, a memory, and/or the like.

The network 120 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 120 can use a variety of electronic protocols, such as Ethernet, Internet Protocol (IP), Session Initiation Protocol (SIP), Integrated Services Digital Network (ISDN), email protocols, video protocols, Instant Messaging (IM) protocols, and/or the like. Thus, the network 120 is an electronic communication network configured to carry messages via packets and/or circuit switched communications.

The vendor upgrade server 130 can be or may include any hardware coupled with software that can download new software and/or software upgrade(s) 131 to the user communication endpoints 101A-1-101A-N and 101B-1-101B-N, the communication systems 110A-110N, the communication managers 112A-112B, the application servers 113A-113B, the web servers 114A-114B, and/or the databases 115A-115B. The vendor upgrade server 130 may be a software process that is running on various types of devices. The communication endpoints 101A-1-101A-N and 101B-1-101B-N, the communication systems 110A-110B, the application servers 113A-113B, the web servers 114A-114B, the databases 115A-115B may be part of an enterprise network of a customer or may be separate systems of different customers. The communication endpoints 101A-1-101A-N and 101B-1-101B-N, the communication systems 110A-110B, the application servers 113A-113B, the web servers 114A-114B, the databases 115A-115B may be production devices, test devices, and/or the like.

The vendor upgrade server 130 further comprises software upgrade(s) 131, customer profile(s) 132, upgrade profile(s) 133, and an Artificial Intelligence (AI) module 134.

The software upgrade(s) 131 can be or may include any update or new software, such as, an initial release of software, a patch, a single bug fix, a security patch, a service pack, a minor functionality change, a major functionality change, a specific feature(s) change, and/or the like.

The customer profile(s) 132 are profiles of where a customer defines various upgrade requirements that are used to determine whether to download one or more of the software upgrades 131. The customer profile(s) 132 may be based on a particular type of software upgrade 131, such as, an new upgrade of the communication endpoints 101A-1-101A-N/101B-1-101B-N, a new upgrade of a communication manager 112, a new upgrade of an application server 113, a new software upgrade 131 of a web server 114, a new software upgrade 131 of a database 115 (or elements within the database 115), and/or the like. The customer profiles 132 may be for one or more customers. For example, a first customer may own the communication system 110A and a second customer may own the communication system 110B. In this example, both customers can define different customer profiles 132.

The upgrade profile(s) 133 are profiles that are defined by the vendor of the software upgrade(s) 131. A vendor may be a person, a company, an organization, a group, an enterprise, and/or the like.

The upgrade profile(s) 133 define various attributes that are associated with individual software upgrade(s) 131. The upgrade profile(s) 133 may be defined for specific customers. In one embodiment an upgrade profile 133 may be for an initial release of software.

The Artificial Intelligence (AI) module 134 can be or may include any software/hardware that can monitor various characteristics associated with the software upgrade(s) 131, the customer profile(s) 132, the upgrade profiles 133, the installation process, and/or the like. The AI module 134, based on a history, may automatically change/monitor one or more of the customer profile(s) 132, change/monitor the upgrade profiles 133, modify the installation process, and/or the like.

Although not shown, additional elements may be included in the first illustrative system 110 that can receive software upgrade(s) 131 via the vendor upgrade server 130. For example, a storage server may be upgraded using the vendor upgrade server 130.

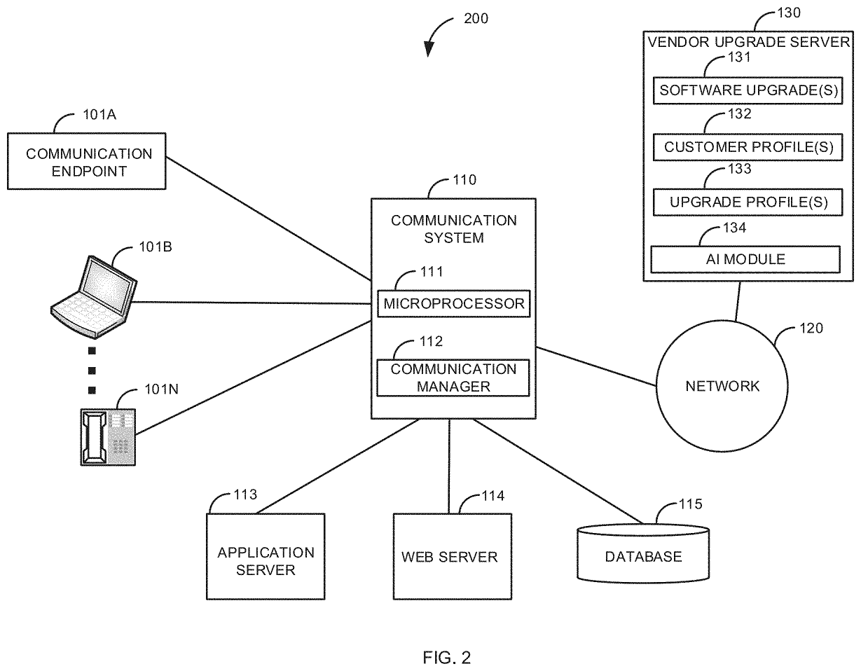

FIG. 2 is a block diagram of a second illustrative system 200 for automating a software download process. The second illustrative system 200 comprises communication endpoints 101A-101N, a communication system 110, an application server 113, a web server 114, a database 115, the network 120 and the vendor upgrade server 130. FIG. 2 is a second exemplary example, of how software upgrade(s) 131 can be installed on one or more network elements (101, 110, 112, 113, 114, and 115). In FIG. 2, the network 120 may be a private corporate network that that uses the vendor server 130 to upgrade any network element(s) on the network 120.

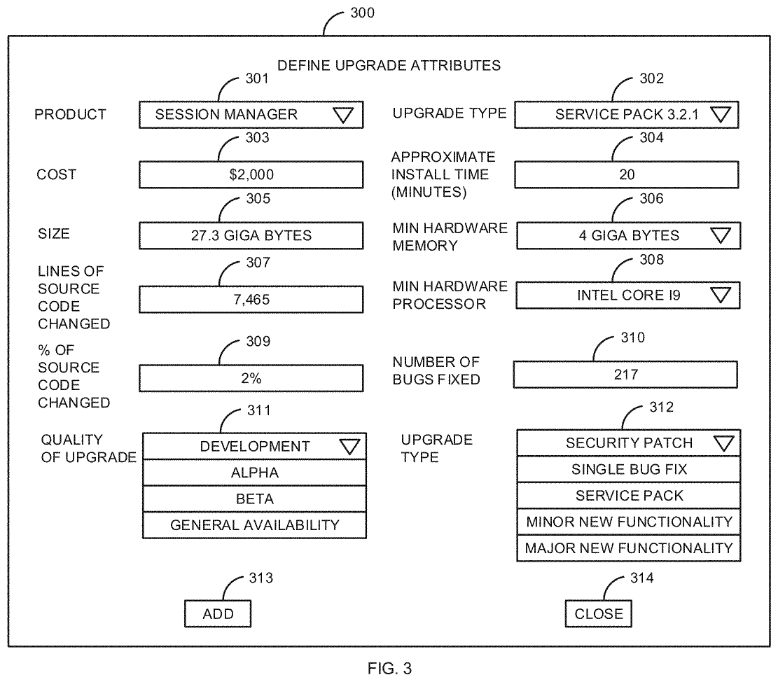

FIG. 3 is a diagram of a user interface 300 for defining software upgrade attributes. Illustratively, the communication endpoints 101, the communication system 110, the communication managers 112, the application servers 113, the web servers 114, the databases 115, the vendor upgrade server 130, the software upgrade(s) 131, the customer profile(s) 132, the upgrade profile(s) 133, and the AI module 134 are stored-program-controlled entities, such as a computer or microprocessor 111, which performs the method of FIGS. 3-8 and the processes described herein by executing program instructions stored in a computer readable storage medium, such as a memory (i.e., a computer memory, a hard disk, and/or the like). Although the methods described in FIGS. 3-8 are shown in a specific order, one of skill in the art would recognize that the steps in FIGS. 3-8 may be implemented in different orders and/or be implemented in a multi-threaded environment. Moreover, various steps/elements may be omitted or added based on implementation.

The user interface 300 is used by a user (e.g., an administrator of the vendor upgrade server 130) to define attributes that are associated with a new release of a product or a software upgrade 131. The user interface comprises a product drop-down-menu 301, a upgrade type drop-down-menu 302, a cost field 303, an approximate install time field 304, a size field 305, a minimum hardware memory drop-down-menu 306, a lines of source code changed field 307, a minimum hardware processor drop-down-menu 308, a percentage of source code changed field 309, a number of bugs fixed field 310, an quality of upgrade drop-down-menu 311, a upgrade type drop-down-menu 312, an add button 313, and a close button 314. As one of skill in the art work would recognize, other types of fields/drop-down-menus may be displayed that define upgrade attributes for a particular type of product/software upgrade 131.

When each new software product/software upgrade 131 is added to the vendor upgrade server 130, the result is that the product drop-down-menu 301 has a list of software products that are supported by the vendor upgrade server 130. The upgrade type drop-down-menu 302 has a list of one or more software upgrades 131 (could show first release if it is a first release). In FIG. 3, an administrator (a user) has selected the product drop-down-menu 301 to “SESSION MANAGER” and the upgrade type drop-down-menu 302 to “SERVICE PACK 3.2.1.”

After selecting the product drop-down-menu 301 and the upgrade type drop-down-menu 302, the software upgrade attributes 303-312 are displayed to the administrator. The software upgrade attributes that are displayed to the administrator in the user interface 300 may be different depending upon the selected software product and/or the upgrade type.

The administrator can then select/enter the necessary values for the particular software product/software upgrade 131. In FIG. 3, the administrator has entered a cost of the software upgrade 131 for SERVICE PACK 3.2.1 to be $2,000 in the cost field 303, an approximate install time to be 20 minutes in the approximate install time field 304, a size of the SERVICE PACK 3.2.1 to be 27.3 gigabytes in the size field 305, selected a minimum hardware memory to be 4 gigabytes in the minimum hardware memory drop-down-menu 306, a number of lines of source code changed to be 7,465 in the lines of source code changed field 307, selected the minimum hardware processor to be an INTEL CORE I9 processor in the minimum hardware processor drop-down-menu 308, a percentage of source code changes to be 2% in the percentage of source code changed field 309, a number of bugs fixed to be 217 in the number of bugs fixed field 310, selected a quality of upgrade to be “DEVELOPMENT” in the quality of upgrade drop-down-menu 311, and selected the upgrade type to be “SECURITY PATCH” in the upgrade type drop-down-menu 312.

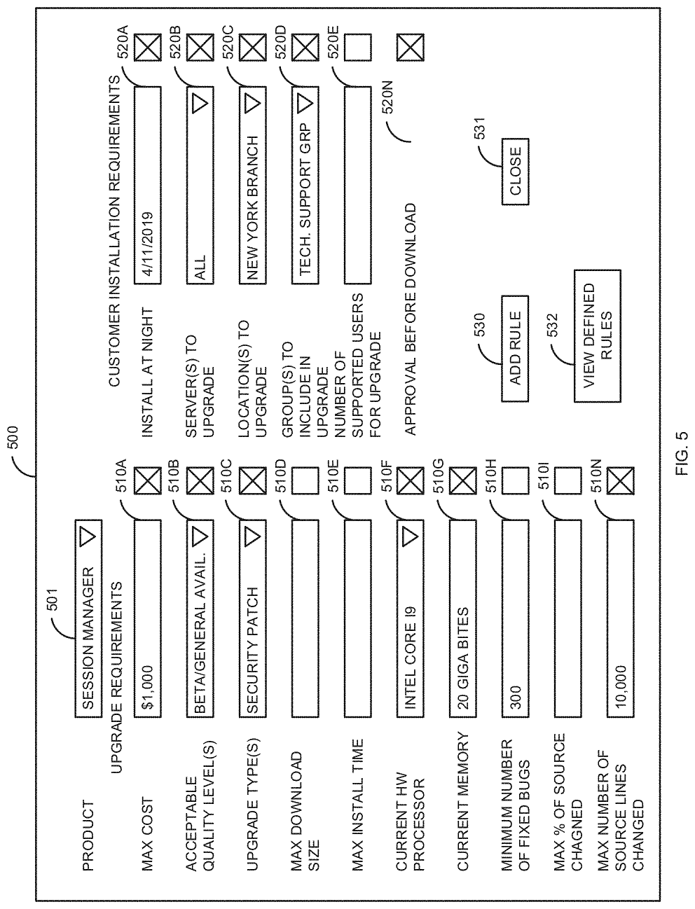

If the administrator wants to add the selected software upgrade attributes to the upgrade profile(s) 133, the administrator can select the add button 313. Otherwise, the administrator can select the close button 314 to close the user interface 300. The software upgrade attributes are then used in conjunction with the upgrade requirements as discussed in FIG. 5. In one embodiment, some or all of the upgrade attributes 301-312 may be pre-populated and cannot be changed.

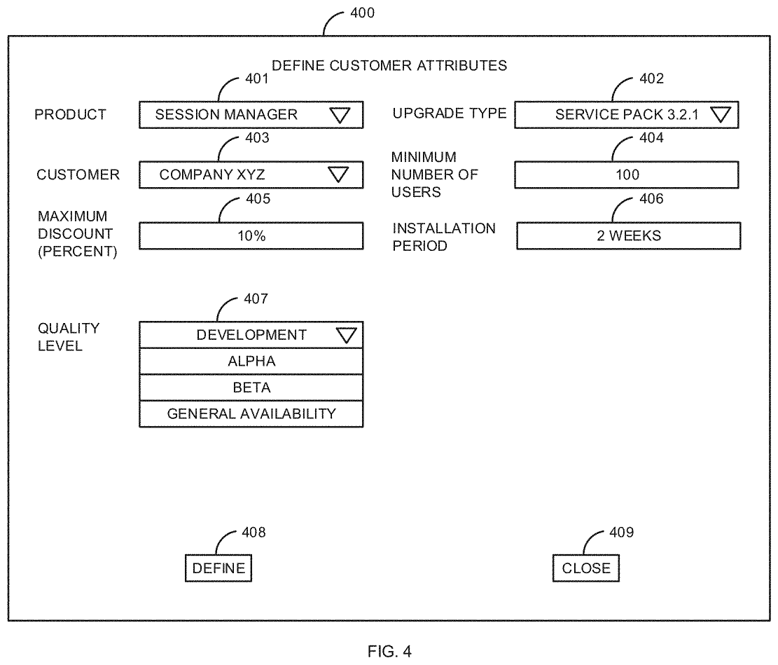

FIG. 4 is a diagram of a user interface 400 for defining software upgrade attributes for a specific customer. The user interface 400 comprises a product drop-down-menu 401, a upgrade type drop-down-menu 402, a customer drop-down-menu 403, a minimum number of users field 404, a maximum discount field 405, an installation period 406, an quality level drop-down-menu 407, a define button 408, and a close button 409. As one of skill in the art would recognize, additional fields/drop-down-menus may be displayed to an administrator to define attributes that specify how requirements of when and how a product/upgrade may be downloaded by a specific customer.

In order to define attributes for a specific customer the administrator selects the product by using the product drop-down-menu 401 (SESSION MANAGER in this example). The administrator also selects the upgrade type 402 (SERVICE PACK 3.2.1 in this example). The administrator then selects a customer from the customer drop-down-menu 403 (COMPANY XYZ in this example). A customer may be a company, an enterprise, an organization, an individual person, a partnership, an entity, and/or the like.

The administrator then defines specific customer attributes that the administrator wants to set for a specific customer for the selected product/upgrade type. For example, the administrator may set that if this customer wants to upgrade, the customer must upgrade a minimum number of users to 100 as shown in the minimum number of users field 404.

The administrator can define a maximum discount that is allowed for this specific customer. For example, as shown in FIG. 4, the administrator has set a maximum discount of 10% for company XYZ.

The administrator can define a time period for when the customer can install the product/upgrade type using the installation period field 406. For example, as shown in FIG. 4, the administrator has defined that the customer (company XYZ) must install the service pack 3.2.1 within 2 weeks of its release.

The administrator can define a minimum quality level that the customer is allowed to download using the quality level drop-down-menu 407. For example, if the administrator selected the quality level of “BETA,” the customer company XYZ would only be able to download beta or general availability loads of service pack 3.2.1. This way, an administrator may limit a particular customer from receiving lower quality upgrades.

The administrator can then store the customer attributes by selecting the define button 408. The administrator may exit the user interface 400 by selecting the close button 409.

FIG. 5 is a diagram of a user interface 500 for defining customer upgrade requirements and customer installation requirements 520. The user interface 500 is displayed to the customer. For example, the user interface 500 is displayed, based on an authentication process, to the customer via a web page provided by the vendor upgrade server 130.

The user interface 500 is used by the customer to define one or more rules that allow a specific product/software upgrade 131 to be downloaded. The user interface 500 also allows the customer to define one or more installation rules to be followed if the rules for the download are met.

The user interface 500 has a product drop-down-menu 501. The customer selects a product (SESSION MANAGER in this example) using the product drop-down-menu 501. As a result, upgrade attributes 510A-510N and customer installation requirements 520A-520N are displayed to the customer. The upgrade attributes 510A-510N and customer installation requirements 520A-520N may change based on the selected upgrade attributes 301-312 and the selected customer attributes 401-407. For example, the acceptable quality level field 510B may be limited in the number of choices depending on how the quality level drop-down-menu 407 has been defined by the administrator.

The user interface further includes the upgrade requirements 510A-510N. The upgrade requirements 510A-510N include a maximum cost field 510A, an acceptable quality level(s) drop-down-menu 510B, an upgrade type(s) drop-down-menu 510C, a maximum download size field 510D, a maximum install time field 510E, a current hardware processor drop-down-menu 510F, a current memory field 510G, a minimum number of fixed bugs field 510H, a maximum percentage of source code changed field 510I, and a maximum number of source lines changed field 510N. Each of the drop-down-menus/fields 510A-510N has a corresponding check box that can be selected when the customer wants the drop-down-menu/field to be added to the download rule.

The maximum cost field 510A allows the customer to enter a maximum cost that the customer will allow to be charged in order to allow upgrade. In FIG. 5, the customer has entered the value $1,000 as the maximum cost the customer will pay for an upgrade. The customer has also selected the associated checkbox for the maximum cost field 510A to make the maximum cost field part of the download rule.

The acceptable quality level(s) drop-down-menu 510B allows the customer to select an acceptable quality level. For example, as shown in FIG. 5, the customer has selected the beta/general availability as the only two acceptable quality levels that the customer will allow. The customer has selected the associated checkbox for the acceptable quality level(s) drop-down-menu 510B to make the selected acceptable quality level(s) (beta/general availability) be part of the download rule.

The upgrade types drop-down-menu 510C allows the customer to select which upgrade type(s) the customer will allow. For example, as shown in FIG. 5, the customer has selected to only allow security patches to be downloaded. The customer has selected the associated checkbox for the upgrade type(s) drop-down-menu 510C to make the selected upgrade type (security patch) to be part of the download rule.

The maximum download field 510D allows the customer to set a maximum size of the download. In FIG. 5, the customer has not entered a maximum download size and has not selected the associated check box to be part of the download rule.

The maximum install time field 510E allows the customer to set a maximum install time of the download. In FIG. 5, the customer has not entered a maximum install time and has not selected the associated check box to be part of the download rule. In addition to the maximum install time field 510E, a maximum service outage time field may be displayed (not shown). The maximum service outage time field identifies a maximum amount of time that the customer will allow for an outage while the new service is being downloaded/installed (e.g., how long the communication system 110 will be out of service while being updated). Moreover, a must wait for service usage level field (not shown) may be set by the customer. The must wait for service usage level field allows the customer to define a service usage level (e.g., a number of active communication sessions on a specific module) that will be required before the installation takes place. For example, the upgrade procedure may place the system in a mode to deny new services (e.g., new communication sessions). Once the activity level reaches a specified level (e.g., zero communication sessions), the download occurs. The level may be a number or range.

The current hardware processor drop-down-menu 510F is selected by the customer based on the processor(s) of the system(s) to be downloaded. As shown in FIG. 5, the customer has selected the Intel Core I9™ as the current processor. The customer has also selected the associated checkbox to add the selected current hardware processor to the rule. In one embodiment, the associated check box is automatically checked and cannot be unchecked. In other words, in this example, the current processor drop-down drop-down-menu is a required menu that has to be selected by the customer.

The current memory check-box-menu 510G is selected by the customer based on the memory of the system(s) to be downloaded. For example, as shown in FIG. 5, the user has selected 20 gigabytes of memory. The customer has also selected the associated check box to add the selected current memory into the rule.

The minimum number of fixed bugs field 510H allows the customer to select a minimum number of bugs that need to be fix over what the customer currently has. As shown in FIG. 5, the customer has entered that 300 bugs must be fixed. However, the customer has not selected the associated checkbox.

The maximum percentage of source code changed field 510I allows the customer to enter a maximum percentage of source code that can be changed. As shown in FIG. 5, the customer has not entered a maximum percent of source code changed value or selected the associated check box.

The maximum number of source lines changed field 510N allows the customer to enter a value for the maximum number of lines of source lines changed. As shown in FIG. 5, the customer has entered the value of 10,000 for the maximum number of source lines changed field 510N. The customer has also selected the corresponding check box to make the entered maximum number of source lines changed to be part of the download rule.

Although not shown, additional upgrade requirements may be shown to the customer, such as, a discount on the cost of the software upgrade 131, a credit for installing the software upgrade 131, a functionality of the software upgrade 131, a type of bug fix in the software upgrade 131, a number of previous installs of the software upgrade 131, a time period from release of the software upgrade 131, a sum of time that the software upgrade 131 has been running on other downloaded systems, a total number of users using the software upgrade 131, a percentage of other customers who have installed the software upgrade 131, and/or the like.

Although FIG. 5 is shown where each upgrade requirement 510A-510N are based on an AND operator, one if skill in the art would recognize that other types of operators may be used to define an upgrade rule. For example, AND, OR, exclusive OR, NOT, and/or various combinations of all of the above may be used to generate a defined rule.

In addition, the customer may define multiple rules that can be used to determine whether a software upgrade 131 is downloaded. The customer may define that the software download 131 will occur based on one and/or two rules meeting various combinations of the upgrade requirements 510A-510N. For example, a customer may define one rule for an alpha release and a second rule for a beta release.

The user interface 500 includes customer installation requirements 520A-520N. The customer installation requirements 520A-520N allow the customer to define specific rules associated with the download (assuming that all the conditions of the rule have been met). The customer installation requirements 520A-520N include an install at night field 520A, a server(s) to upgrade drop-down-menu 520B, a location(s) to upgrade drop-down-menu 520C, a group(s) to include in upgrade drop-down-menu 520D, a number of supported users field 520E, and an approval before download check box 520N.

The install at night field 520A allows the customer to enter a date of when to install the upgrade (e.g., at 12:00 midnight). As shown in FIG. 5, the customer has entered the date of Apr. 11, 2019 as the installation date. The customer has also selected the associated check box to make the entered install at night date to be part of the installation rule.

The server(s) to upgrade drop-down-menu 520B allows the customer to select which server(s) to upgrade. The server(s) to upgrade drop-down menu 520B may be based on a configuration of the customer's systems, based on a previous software download history, and/or the like. For example, if the customer previously downloaded two different servers with the product session manager, the servers to upgrade drop-down-menu 520B will have both servers in the server(s) to upgrade drop-down-menu 520B. As shown in FIG. 5, the customer has selected to upgrade all of the customer's servers. The customer has also selected the associated check box to add the selected servers to the download rule.

If the product being upgraded is not a server, the upgrade to server(s) drop-down-menu 520B may show a communication endpoint(s) 101, a database(s) 115, and/or the like. The servers to upgrade drop-down-menu 520B may show a combination of servers (e.g., application server 113, web server 114, etc.), user communication devices 101, database 115, and/or the like depending upon the configuration of the customer's network. In one embodiment, each server and its type may be displayed.

The location(s) to upgrade drop-down-menu 520C allows the customer to upgrade a particular location. The locations are determined based on different locations of the servers (or other devices that are being downloaded). For example, as shown in FIG. 5, the customer has selected to download all the servers in the New York branch. The customer has also selected the associated check box to make the selected location(s) to upgrade to be part of the download rule.

The group(s) to include in upgrade drop-down-menu 520D allows the customer to select one or more groups of users that will use the upgrade. For example, as shown in FIG. 5, the tech support group will be the only users receiving the new upgrade. The associated check box has also been selected to add the selected group to be part of the upgrade.

The number of supported users field 520E allows the customer to identify a number of user to will receive and/or have access to the new upgrade. For example, if the new upgrade adds a new telephone functionality, only the defined number of users will receive/have access to the new telephone functionality. As shown in FIG. 5, the customer has not entered a value or selected the associated check box for the number of supported users for upgrade field 520E.

The approval before download check box 520N, when selected, will send a notification message to the customer (e.g., a designed user) to approve the download. If not selected, the download is done automatically. In addition, an approval before install field (not shown) may also be displayed to the customer. The approval before install field allows the customer to approve a download before it is installed.

Although not shown, other types of customer installation requirements 520 may be used, such as, a specific time when the software upgrade will be installed, a time period when the software upgrade will be installed, a network traffic level, a portion of the system to install the software upgrade, installing the software upgrade to a test system, and/or the like.

If the customer wants to add the upgrade rule/installation rule, the customer selects the add rule button 530. The rule is added and stored in the customer profile 132. If the customer then wants to see the defined rule(s), the customer can select the view defined rules button 532. The customer can close the user interface 500 by selecting the close button 531. Although not shown, the customer may be able to delete a defined rule.

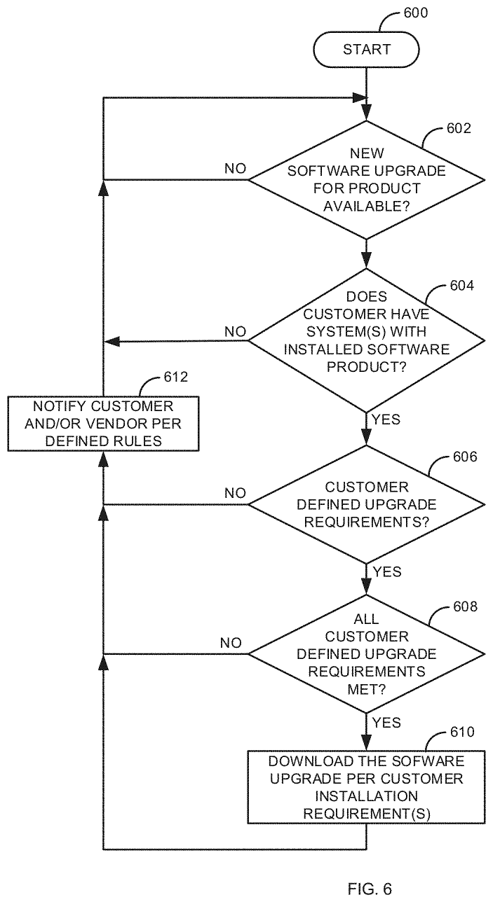

FIG. 6 is a flow diagram of a process for automating a software download process. The process starts in step 600. The vendor upgrade server 130 determines, in step 602, if a new software upgrade 131 is available for a software product. If new software upgrade 131 is not available in step 602, the process of step 602 repeats.

Otherwise, if a new software upgrade 131 is available in step 602, the vendor upgrade server 130 determines, in step 604, if the customer has one or more systems with installed with the software product. The vendor upgrade server 130 may determine that the customer has one or more systems installed with the software product in various ways, such as, based on previous installations, based on receiving messages from the installed software product, based on an established communication session with the software product, and/or the like. If the customer does not have one or more systems installed with the software product, the process goes back to step 602.

If the customer does have one or more systems installed with the software product in step 604, the vendor upgrade server 130 determines, in step 606, if the customer has defined upgrade requirements. For example, as described in FIG. 5, the customer may have selected one or more of the upgrade requirements 510A-510N to define a rule for the software upgrade 131. If the customer has not defined any upgrade requirements in step 606, the process goes to step 612 where the customer and/or vendor is notified per defined rules. The defined rules for the message of step 612 may be different or the same for each customer. For example, a message may be sent to only select customers to notify the customer of the newly available software upgrade 131 to allow the customer to go and set up a new rule to download the new software upgrade 131. The vendor (an administrator) may be also notified in step 612. The process then goes back to step 602.

Otherwise, if the customer has defined upgrade requirements in step 606, the vendor upgrade server 130 determines, in step 608, if all the customer upgrade requirements 510 have been met. For example, as shown in FIG. 5, each of the selected upgrade requirements 510 (maximum cost of $1,000 (510A), must be beta or general availability software (510B), is a security patch (510C), must work with an Intel Core I9 processor (510F), must work with 20 gigabytes of memory (510G), and have a maximum number of source lines changed (510N) must be meet. If any of the customer upgrade requirements 510 are not met in step 608, the process goes to step 612 where the customer and/or vendor are notified of the failure to not meet each of the defined rules. For example, if the only customer upgrade requirement 510 that was not met was the security patch requirement 510C (e.g., it is a general bug fix), the customer and/or vendor (or neither based on what rules are defined) may be notified in step 612. The process then goes back to step 602.

Otherwise, if all the defined upgrade requirements 510 have been met in step 608, the software upgrade 131 is downloaded per the customer installation requirements 520. For example, as shown in FIG. 5, the software upgrade 131 will be installed on Apr. 11, 2019 at night to all servers in the New York branch for only members of the tech support group. In addition, the customer must approve before the software upgrade 131 is downloaded. The process then goes to step 612 where the customer and/or vendor is notified of the download. For example, the customer will be notified when the software upgrade 131 was completed (if successful).

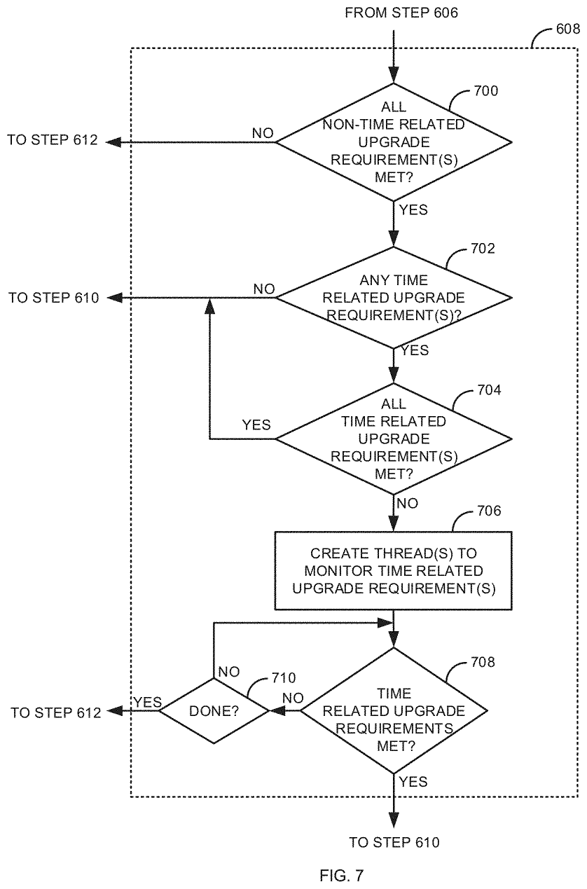

FIG. 7 is a flow diagram of a process for managing time related customer upgrade requirements 510. The process of FIG. 7 is an exemplary embodiment of step 608 of FIG. 6. After it is determined, in step 606, that the customer has defined upgrade requirements 510, the vendor upgrade server 130 determines if all non-time related upgrade requirements 510 have been met. For example, the upgrade requirements 510A-510N are non-time based upgrade requirements because each of the upgrade requirements 510A-510N can be determined when the new software upgrade 131 is made available.

However, other upgrade requirements 510 may be time sensitive. For example, the customer may specify that the software upgrade 131 should not be installed until a specific number of other customers have installed the software upgrade 131. The customer may specify that the download may not occur: until after a time period from release of the software upgrade 131 has expired, until a sum of time that the software upgrade 131 has been running on other downloaded systems has been met, until a specific number of users are using the software upgrade 131, until a percentage of other customers have installed the software upgrade 131, and/or the like.

If all the non-time related upgrade requirements have not been met in step 700, the process goes to step 612. Otherwise, if all the non-time related upgrade requirements 510 have been met in step 700, the vendor upgrade server 130 determines, in step 702, if there are any time related upgrade requirements 510. If there are not any time related upgrade requirements 510, in step 702, the process goes to step 610 where the software upgrade 131 is download per the customer's installation requirements 520. If there are any time related upgrade requirements 510 in step 702, the vendor upgrade server 130 determines, in step 704, if all the time related update requirements 510 have been met. If all the time related update requirements 510 have been met in step 704, the process goes to step 610 where the software upgrade 131 is download per the customer's installation requirements 520. For example, if the customer defined a rule with the requirement that two weeks after a beta release, to download the software upgrades 131, if the two week period has expired for a beta release, the beta release of the software upgrade 131 in installed in step 610 according the customer's installation requirements 520.

Otherwise, if all the time related update requirements have not been met in step 704, the vendor upgrade server 130 creates one or more threads (processes, daemons, interrupt service routines, etc.) to monitor the time related upgrade requirements 510 in step 706. The vendor upgrade server 130 determines, in step 708, if the time related upgrade requirements 510 have been meet. If the time related upgrade requirements 510 have not been met in step 708, the vendor upgrade server 130 determines if the process is done. For example, a newer release of the software upgrade 131 may be a signal that the time related update requirement(s) 510 are no longer valid. If the process is done in step 710, the process goes to step 612. Otherwise, if the process is not done in step 710, the process goes back to step 708. If all the time release attributes have been met in step 708, the process goes to step 610 where the software upgrade 131 is download per the customer's installation requirements 520.

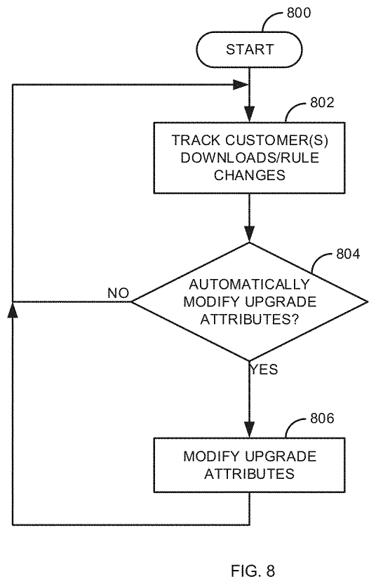

FIG. 8 is a flow diagram of a process for using Artificial Intelligence (AI) in managing a download process. The process starts in step 800. The AI module 134 tracks the customer downloads and changes to rules in step 802. For example, the AI module 134 can track how many customers have downloaded a software upgrade 131 (e.g., a percentage). The AI module 134 can track changes to rules. For example, the AI module 134 can track if multiple customers change their acceptable quality level to a higher levels over time. This may indicate that the quality level is not high enough.

The AI module 134 determines, in step 804, whether to modify any of the upgrade attributes (e.g., upgrade attributes 301-312). For example, the quality of the upgrade value 311 may be automatically changed by the AI module 134 in step 804 to higher value (e.g., from alpha to beta) based on a number of customer downloads, changes to the rules (e.g., a number of customers change the rule from alpha to beta after using alpha version versus changing the rule from beta to general availability), a number users using the software upgrade 131, a number of customers downloading the software upgrade 131, a change in a rule by a number of customers, and/or the like.

If the AI module 134 determines not to modify any of the upgrade attributes in step 804, the process goes back to step 802. Otherwise, the AI module 134 modifies the upgrade attributes in step 806. For example, the quality of the upgrade value 311 may be automatically changed from alpha to beta. The process then goes to step 802.

All the processes described herein may be also used for an initial release of a software product. For example, the upgrade attributes 303-312, the specific customer attributes 403-407, and the upgrade requirements 510A-510N may only apply to the software product when it is initially released.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJS™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A system comprising:
a microprocessor; and
a computer readable medium, coupled with the microprocessor and comprising microprocessor readable and executable instructions that, when executed by the microprocessor, cause the microprocessor to:
determine that a software upgrade is available for a software product;
identify a system of a customer that has been installed with the software product;
identify one or more customer upgrade requirements, wherein the one or more customer upgrade requirements are based on one or more product attributes associated with the software upgrade;
determine if the one or more customer upgrade requirements have been met, wherein the one or more customer installation requirements comprise at least one of: a subgroup of all groups of users of the software product, a network traffic level, a portion of the system to install the software upgrade, and installing the software upgrade to a test system; and
in response to determining that the one or more customer upgrade requirements have been meet, downloading the software upgrade to the software product in the system.

2. The system of claim 1, wherein the one or more customer upgrade requirements comprise at least one of: a cost of the software upgrade, a discount on the cost of the software upgrade, a credit for installing the software upgrade, a functionality of the software upgrade, a quality level of the software upgrade, an amount of time to install the software upgrade, a type of bug fix in the software upgrade, a number of previous installs of the software upgrade, a time period from release of the software upgrade, a sum of time that the software upgrade has been running on other downloaded systems, a total number of users using the software upgrade, a maximum service outage time, a must wait for service usage level, and a percentage of other customers who have installed the software upgrade.

3. The system of claim 1, wherein downloading the software upgrade to the software product in the system is based on one or more customer installation requirements.

4. The system of claim 3, wherein the one or more customer installation requirements further comprises at least one of: a specific time when the software upgrade will be installed, a time period when the software upgrade will be installed, a number of users who receive the software upgrade, a location of the software upgrade.

5. The system of claim 1, wherein downloading the software upgrade to the software product on the system is based on at least one of an approval before download and an approval before install.

6. The system of claim 1, wherein downloading the software upgrade to the software product on the system is done automatically.

7. The system of claim 1, wherein the one or more customer upgrade requirements comprises one or more time related upgrade requirements and wherein the microprocessor readable and executable instructions further cause the microprocessor to:
create one or more threads to monitor the one or more time related upgrade requirements.

8. The system of claim 7, wherein the one or more threads determines that the one or more time related upgrade requirements has been met, which results in the downloading of the software upgrade to the software product in the system.

9. The system of claim 7, wherein the one or more time related upgrade requirements comprises at least one of: a number of previous installs of the software upgrade, a time period from release of the software upgrade, a sum of time that the software upgrade has been running on other downloaded systems, a total number of users using the software upgrade, and a percentage of other customers who have installed the software upgrade.

10. The system of claim 1, wherein an artificial intelligence process automatically changes a quality level of the software upgraded based on at least one of: a number users using the software upgrade, a number of customers downloading the software upgrade, and a change in a rule by a number of customers.

11. A method comprising:
determining, by a microprocessor, that a software upgrade is available for a software product;
identifying, by the microprocessor, a system of a customer that has been installed with the software product;
identifying, by the microprocessor, one or more customer upgrade requirements, wherein the one or more customer upgrade requirements are based on one or more product attributes associated with the software upgrade and wherein the one or more customer installation requirements comprise at least one of: a subgroup of all groups of users of the software product, a network traffic level, a portion of the system to install the software upgrade, and installing the software upgrade to a test system;
determining, by the microprocessor, if the one or more customer upgrade requirements have been met; and
in response to determining that the one or more customer upgrade requirements have been meet, downloading the software upgrade to the software product in the system.

12. The method of claim 11, wherein the one or more customer upgrade requirements comprise at least one of: a cost of the software upgrade, a discount on the cost of the software upgrade, a credit for installing the software upgrade, a functionality of the software upgrade, a quality level of the software upgrade, an amount of time to install the software upgrade, a type of bug fix in the software upgrade, a number of previous installs of the software upgrade, a time period from release of the software upgrade, a sum of time that the software upgrade has been running on other downloaded systems, a total number of users using the software upgrade, a maximum service outage time, a must wait for service usage level, and a percentage of other customers who have installed the software upgrade.

13. The method of claim 11, wherein downloading the software upgrade to the software product in the system is based on one or more customer installation requirements.

14. The method of claim 13, wherein the one or more customer installation requirements further comprise at least one of: a specific time when the software upgrade will be installed, a time period when the software upgrade will be installed, a number of users who receive the software upgrade, and a location of the software upgrade.

15. The method of claim 11, wherein downloading the software upgrade to the software product on the system is done automatically.

16. The method of claim 11, wherein the one or more customer upgrade requirements comprises one or more time related upgrade requirements and further comprising:
creating one or more threads to monitor the one or more time related upgrade requirements.

17. The method of claim 16, wherein the one or more threads determines that the one or more time related upgrade requirements has been met, which results in the downloading of the software upgrade to the software product in the system.

18. The method of claim 16, wherein the one or more time related upgrade requirements comprises at least one of: a number of previous installs of the software upgrade, a time period from release of the software upgrade, a sum of time that the software upgrade has been running on other downloaded systems, a total number of users using the software upgrade, and a percentage of other customers who have installed the software upgrade.

19. The method of claim 11, wherein an artificial intelligence process automatically changes a quality level of the software upgraded based on at least one of: a number users using the software upgrade, a number of customers downloading the software upgrade, and a change in a rule by a number of customers.

20. A system comprising:
a microprocessor; and
a computer readable medium, coupled with the microprocessor and comprising microprocessor readable and executable instructions that, when executed by the microprocessor, cause the microprocessor to:
determine that a new software product is available for downloading;
identify a system of a customer;
identify one or more customer upgrade requirements, wherein the one or more customer upgrade requirements are based on one or more product attributes associated with the software product and wherein the one or more customer installation requirements comprise at least one of: a subgroup of all groups of users of the software product, a network traffic level, a portion of the system to install the software upgrade, and installing the software upgrade to a test system;
determine if the one or more customer upgrade requirements have been met; and
in response to determining that the one or more customer upgrade requirements have been met, downloading the software product to the system.
